(19) United States
(12) Patent Application Publication
(10) Pub. No.: US 2025/0268419 A1
(43) Pub. Date: Aug. 28, 2025

(54) Electronic Module for at Least One Kitchen Appliance, Preferably Cookware Item

(71) Applicant: ZWILLING J.A. Henckels AG, Solingen (DE)

(72) Inventors: Sebastian Mader, Solingen (DE); Bernard Devriendt, Solingen (DE); Kenneth Willaerts, Solingen (DE)

(21) Appl. No.: 18/701,175

(22) PCT Filed: Oct. 13, 2022
(86) PCT No.: PCT/EP2022/078485

§ 371 Date: Apr. 12, 2024

(30) Foreign Application Priority Data
Oct. 15, 2021 (DE) 10 2021 126 811.7

(51) Int. Cl. A47J 36/32

(52) U.S. Cl. CPC A47J 36/321

(57) ABSTRACT

An electronic module for at least one kitchen appliance at least comprising one module housing at least one electronic component, that is arranged in the module housing, and at least one electrical energy storage, that is arranged in the module housing and connected to the electronic component, wherein The electronic module is configured to detect information from the kitchen appliance. The electronic module is intended and set up for the purpose of being placed with magnetic force in at least one predefined arrangement relative to the kitchen appliance being detachably held at the kitchen appliance.

The invention relates to an electronic module for at least one kitchen appliance, such as at least one cookware item and a cookware item with the electronic module. The electronic module is particularly suitable for being detachably connected to at least one cookware item, in particular a number of cookware items, and to provide a user with information about a use of the cookware item, such as about the current temperature of the cookware item.

Cookware items, like for example pots or pans, are known which have a means for indicating when a certain temperature of the cookware item concerned has been reached. For example, rectangular, circular or ring-shaped elements are known, which change color when reaching a specified temperature of the cookware item, in order to indicate that the temperature has been reached. If the temperature goes below the specified temperature, the element can regain its original color. Often metallic elements with a greyish initial color are being used, that take on a red color when reaching a specified temperature.

A disadvantage of the known cookware items is that they offer only a low degree of interaction between the user and the cookware item in question. Known cookware items are normally not equipped to assist the user as advantageously as possible during the planning and/or execution of a cooking process that is carried out with the cookware item.

Based on this, it is the object of the present invention to solve the described problems of the state of the art at least partially. Particularly an electronic module for at least one kitchen appliance or cookware item and a cookware item shall be provided, that at least contributes to improve the interaction between a user and the cookware item in question. Particularly the electronic module or the cookware item shall assist the user in the planning and/or execution of a cooking process that is carried out with the cookware item.

These objects are solved by the features of the independent claims. Further advantageous embodiments of the solution proposed here are provided in the dependent claims. It should be pointed out that the features listed individually in the dependent claims can be combined with each other in any, technologically meaningful way and define further embodiments of the invention. Furthermore, the features specified in the claims are further specified and explained in the description, whereby further preferred embodiments are shown.

This is helped by an electronic module for at least one kitchen appliance, preferably at least one cookware item, at least comprising:
one module housing
at least one electronic component, that is arranged in the module housing,
at least one electrical energy storage, that is arranged in the module housing and connected to the electronic component,
wherein the electronic module is configured to detect information from the kitchen appliance (cookware item), wherein the electronic module is intended and set up for the purpose of being placed with magnetic force in at least one predefined arrangement relative to the kitchen appliance (cookware item) and being detachably held at the kitchen appliance (cookware item).

The electronic module can be advantageously combined with various kitchen appliances, for example in the type of an exchangeable module and/or universal module for various applications. The kitchen appliances can be, for example a kitchen machine or the like. Particularly preferably the at least one kitchen appliance is at least one kitchen utensil (i.e., in particular a kitchen appliance without its own electronic control unit) or a cookware item. The electronic module is in particular a unit that can be detachably connected to at least one cookware item, in particular different cookware items. Thus, for example, the electronic module can be connected in the manner of an exchangeable module to a variety of different cookware items or cookware item types. The electronic module can, for example, be used specifically to carry out a cooking process with a particular cookware item. Furthermore, the electronic module can, for example, be used for cleaning purposes and/or to be reconnected to another cookware item or removed. In other words, this can also be described in particular as that the electronic module can be designed to be exchangeable and/or is suitable for use with different types of cookware items. The cookware item can, for example, be a pot or a pan.

The electronic module comprises a module housing. The module housing is preferably at least watertight or gas-tight. This advantageously allows electronic components arranged in the module housing to be shielded from the conditions during the performance of a cooking process using of the cookware item and/or during a washing process. Preferably, the module housing forms a watertight and/or gas-sealed capsule in which at least the at least one electronic component and the at least one electrical energy storage can be accommodated. Preferably, an (outer) housing shape or contour of the module housing is adapted to an (inner) shape or contour of a receptacle of the cookware item for the module housing. For example, the module housing can have the shape of a cube.

The electronic module comprises at least one electronic component arranged in the module housing. The at least one electronic component can, for example, comprise evaluation electronics, power electronics and/or control electronics. The at least one electronic component can, for example include a microcontroller. For example, the at least one electronic component can be in the form of a circuit board. For example, the electronic component can be provided and set up to analyze a sensor signal, for example from a temperature sensor integrated in the cookware item and, if necessary, convert it into a corresponding display signal. The at least one electronic component can, for example, be connected between the electrical energy storage and a display device in the module housing.

The electronic module comprises at least one electrical energy storage, arranged in the module housing and connected to the electronic component. The at least one electrical energy storage can, for example comprise a rechargeable battery and/or a (replaceable) battery (cell). The at least one electrical energy storage can, for example, comprise a (replaceable) standard cell or be (specifically) adapted to an inner contour of the module housing.

The electronic module is set up to detect information from the kitchen appliance (in particular cookware item). The detection can comprise receiving, reading, determining and/or measuring. The information can preferably be sensor data. The information can be transmitted via a (wired or wireless) interface to the kitchen appliance (cookware item). The interface can, for example, be realized by means of an electronic connection element.

The electronic module is intended and set up to be placed by means of magnetic force in at least one predefined arrangement relative to the kitchen appliance (in particular cookware item) and to be detachably held at the kitchen appliance (in particular cookware item). This allows an advantageously secure and yet simple, detachable connection of the electronic module to one or more different cookware items. For example, the electronic module can comprise one or several magnets. If several magnets are provided, their arrangement can, for example, advantageously lead to a desired alignment of the electronic module in relation to the (remaining) cookware item. Alternatively, or cumulatively, at least one section or partial area of the electronic module can be formed by means of a magnetic material. For example, the electronic connection element (explained in more detail below) can be formed with a magnetic metal and/or comprise at least one magnet. It may be provided that the electronic module is intended and set up to be positioned by means of magnetic force in exactly one or a certain predefined arrangement (and/or orientation) relative to the kitchen appliance (cookware item) and attached to the kitchen appliance (cookware item) and to be held detachably (Poka Yoke) on the kitchen appliance (cookware item).

A corresponding magnetic connection can advantageously contribute to the fact that only a manual rough positioning is required to insert the module into a cookware item handle. In this context, the fine positioning is advantageously carried out independently by the magnetic forces at work. It is also advantageous that the module can only be released from the fastening by overcoming the magnetic forces. In particular, the operation of a mechanical unlocking mechanism is omitted. This advantage can, for example facilitate operation with just one hand. Furthermore, the joining and/or releasing of the module can be realized ergonomically and conveniently particularly advantageous. In particular, fixing the module with magnetic forces can eliminate the design effort for a latching mechanism, which usually requires additional shaping elements such as back cuts and/or projections in the product surface. The product can therefore be advantageously designed smoothly or plainly at its outer surfaces, making it advantageously less susceptible to soiling and easier to clean. Furthermore, the externally smooth shape of the product advantageously allows for increased robustness, for example against external mechanical impacts such as a fall. The simple design in particular can also advantageously reduce production costs.

Further advantages of the magnetic connection can be seen in the fact that even in comparatively dirty kitchen environments (for example, due to splashes of fat or grease on the fingers), it is still possible to “clip” the module to and/or into the handle is still possible. In particular, no external tool or device, such as a screwdriver or fastener for positioning or locking is required. Another advantage is that a simple locking/unlocking is also advantageously easy to clean, as the cookware can be cleaned in the dishwasher without the electronics in the electrical module being jeopardized by the conditions in the dishwasher. Furthermore, the cookware is usually functional even without the electronic module (and ergonomic in use).

According to an advantageous embodiment, it is proposed that the electrical module further comprises at least one electronic connection element which is connected to at least the electronic component or the energy storage, wherein the electronic module can be electrically connected to the cookware by means of the connection element. For example, the electronic connection element can penetrate a housing wall of the module housing. For example, this penetration can be made watertight and/or gas-tight. Preferably, the connection element forms an electronic or electrical interface of the electronic module, for example to the (remaining) cookware item and/or at least one peripheral device, such as a charging station. The connection element can be in the form of a plug, for example. The plug can, for example, comprise one or more pins.

With a corresponding connection element, the electrical contact between the electronic module and, for example, a cookware item handle is preferably provided by a mechanical contact in the form of a magnetic connector (“PogoPin”). Via this connector particularly advantageously possible signals for determining the temperature and/or electrical currents for example for charging the electrical energy storage (in particular an accumulator) can be conducted. Alternatively, or cumulatively, the transmission of data and/or energy can be conducted contactlessly by, for example, electromagnetic waves and/or induction. In this context, the magnetic attraction between the electronic module and the cookware item handle can be used for fixing. In this example, however, the need for a physical electrical connector can be advantageously omitted. In this context, electronic measures can be undertaken in the electronic module and, for example, in the cookware item or handle. For example, electronic units for near-field communication (e.g. NFC) and/or inductive energy transfer (e.g. Qi standard) can be provided. One advantage of this embodiment can be seen in the fact that plug elements can be advantageously omitted and that neither the outer casing of the cookware item handles nor of the electronic module are penetrated by plug elements, which can advantageously make the overall system less susceptible to corrosion and loose contacts. In addition, the production, assembly and sealing of the module and the handle can be advantageously simplified. In addition, the system can be made visually simpler.

According to a further advantageous embodiment, it is proposed that the electronic module further comprises a display device. The display device is set up in particular for the optical or visual display of an information in the form of digits, letters, characters or the like. The display device is usually (signal-technically) connected to the electronic component.

The display device can preferably comprise an arrangement of several LEDs. The arrangement of the LEDs can be circular, for example. In particular, the display device can visualize exemplary data or information by means of various circuits or controls of the LEDs within the arrangement. Furthermore, the electronic module can have a cover element to cover the display device. The cover element can, for example, be put in or integrated gas-tight and/or liquid-tight into the module housing above the display device The cover element can be at least partially or completely transparent. The shape of the cover element can match the shape of the display device, in particular the shape of the arrangement of LEDs. In particular if the LEDs are arranged in a circular arrangement, the cover element can have a (corresponding) circular and/or convex viewing area.

Alternatively, or cumulatively, the display device can comprise at least one display. The display can, for example, be a color display and/or a touch-sensitive display (touch display). The display can be round or circular or rectangular in shape.

According to a further advantageous embodiment, it is proposed that the electronic module further comprises a communication device for a wireless communication. The communication device can, for example, be set up for radio transmission, for example via Bluetooth, WLAN or the like. Preferably, the communication device comprises at least one Bluetooth module. The Bluetooth module is particularly preferably a low-energy Bluetooth module. The latter is particularly advantageous in order to conserve the state of charge of the electrical energy storage.

According to a further advantageous embodiment, it is proposed that the electronic module further comprises at least one detection device that is connected to the electronic component. The detection device can comprise, for example, an (RFID) reader or an (RFID) scanner. The detection device can be set up for automatic identification, for example of the type of place of use and/or the type of (connected) cookware item. In particular, the detection device can include an RFID reader that can (automatically) read an RFID code of a cookware item in the vicinity of the electronic module.

The electronic module can also have an input element. This can, for example, be a manually operated button and/or a capacitive touch sensor. Alternatively, or cumulatively, a touch-sensitive display (so-called touch display) could serve as an input element. A user can advantageously control the electronic module via the input element, for example, confirm queries and/or select menu items. Furthermore, the electronic module can also comprise an acoustic element and/or a buzzer or a vibration element to emit, for example, warning messages acoustically and/or through vibration. The actions initiated by means of the control element are at least partially processed in the electronic module itself (e.g. a sequence control for specific, stored cooking processes). In particular, it is not intended that the actions of the user recorded by the input element are transmitted directly to a base remote from the cookware item.

It is possible that inputs, data and signals recorded via the input element are used for an internal learning process, so that the electronic module itself can be adapted to the usual handling and/or preferences of the user, in particular without having to exchange these learning results with external databases.

With a corresponding input element, it is possible to particularly advantageously enable an input or a submission by a user via a touch-sensitive display or a capacitive sensor. Alternatively, or cumulatively an input can be made possible by knocking on the electronic module. For example, the input element can include an (internal) vibration sensor and/or acceleration sensor. In this way, the input element can be advantageously set up to detect a knock on the electronic module. This embodiment can advantageously contribute to saving space and/or costs. A corresponding sensor system can, for example, be integrated particularly advantageously with LEDs in a variant that is as compact as possible.

For example, it is possible to knock and/or turn the cooking appliance to undertake (automatic) settings of (predeterminable) temperatures and/or (predeterminable) times before or during the cooking process.

According to a further aspect, a cookware item with a removable electronic module described here is proposed. The cookware item can be, for example, a pot or a pan.

The electronic module is preferably integrable or integrated into a handle of the cookware item. The electronic module can be integrated at one (free) end of the handle.

It is possible that the cookware item comprises a handle in which a mounting for the removable electronic module is provided. The mounting preferably forms a mounting base and at least two or at least three lateral mounting walls, which hold the electronic module (preferably flush) positioned in the mounting. The mounting can be designed as a mounting being accessible (only) from one side and/or (only) from above, so that the electronic module can (only) be inserted accordingly. At least two mounting walls can provide (opposite) guidance of the module housing when inserting and/or removing the electronic module. It is possible that the electronic module in the mounting does not protrude beyond the remaining surface of the handle, so that it is well protected even when the cookware item is carried by the handles. It is possible that the at least one electronic connection element is provided in one of the mounting walls, in particular in the mounting wall that is closest to the cookware item (pot, pan, etc.). At least one magnet can be provided on or under a mounting wall, in particular to support or generate a movement of the electronic module towards at least one of the mounting walls.

According to an advantageous embodiment, it is proposed that the cookware item is equipped with an integrated temperature sensor that is connectable to the electronic module. The temperature sensor can, for example, be integrated into the basement of the cookware item. For this purpose, the temperature sensor can, for example, be arranged in a channel in the basement wall of the cookware item. A signal line for transmitting a signal from the temperature sensor to the electronic module can, for example, end in the area of a mounting for the electronics module.

According to an advantageous embodiment, it is proposed that the cookware item is equipped with an analogue-digital converter for converting a sensor signal. The analogue-digital converter can be used within the signal line for transmitting a signal of the temperature sensor to the electronic module or within the electronic module.

According to an advantageous embodiment, it is proposed that the cookware item is equipped with a sensor for detecting at least one movement or position of the cookware item. The sensor can be, for example, a position sensor, such as a gyro sensor and/or an acceleration sensor. The sensor can, for example, be integrated in the electronic module.

Method for preparing meals with a cookware item comprising at least the following steps:
a) electing a meal to prepare with an application software (app), which can provide information for the electronic module,
b) connecting the electronic module with the cookware item,
c) performing of a cooking process or a simmering process for preparing the meal in the cookware item,
d) monitoring the cooking process or the simmering process with the electronic module.

The electing of the food to be prepared can, for example, be undertaken from a catalog of suggested dishes. The catalog or the suggested dishes can, for example, be determined on the basis of information about the food currently available in the household. The corresponding determination can, for example, be carried out by the application software. The application software can determine the currently available food stock on the basis of information from a digital shopping list and/or information from a networked or smart refrigerator and/or freezer and/or storage container. The application software can, for example, run on a portable, digital end device, such as a smartphone, tablet or similar, which transmits data to an electronic module described here and/or can exchange data with an electronic module described here.

For example, the electronic module can be connected to a specific type or kind of cookware item that has been determined by the application software and communicated to a user. For undertaking the cooking process or simmering process, the user can, for example, be guided by the application software. For example, the electronic module can contribute to this which gives the user, for example, instructions from the application software acoustically and/or visually and/or by a vibration.

To monitor the cooking process or simmering process, the electronic module can, for example, supervise a temperature curve and/or a compliance with at least one temperature limit value during the cooking process. In this context, the electronic module can, for example, send from the application software, for example, a compliable temperature curve and/or at least one temperature limit value specified by the application software. If the temperature curve and/or the at least one temperature limit value are not complied with, the application software and/or the electronic module can, for example, send the user a message, for example, in the form of an instruction or warning message acoustically and/or visually and/or by a vibration.

According to a further aspect, it is also possible to specify the use of an electronic module described here for monitoring a cooking process or simmering process. The electronic module can, for example, supervise a temperature curve and/or compliance with at least one temperature limit value during the cooking process or simmering process.

The details, features and advantageous embodiments discussed in connection with the electronic module can accordingly also be applied to the cookware item and/or the method and/or the use presented here and vice versa. In this respect, reference is made in full to the corresponding explanations for a closer characterization of the features.

The solution presented here, and its technical environment are explained in more detail below with reference to the figures. It should be noted that the invention should not be limited by the embodiments shown. In particular, it is also possible, unless explicitly shown otherwise, to extract partly aspects of the facts explained in the figures and to combine them with other components and/or findings from other figures and/or the present description. The following show by way of example and schematically:

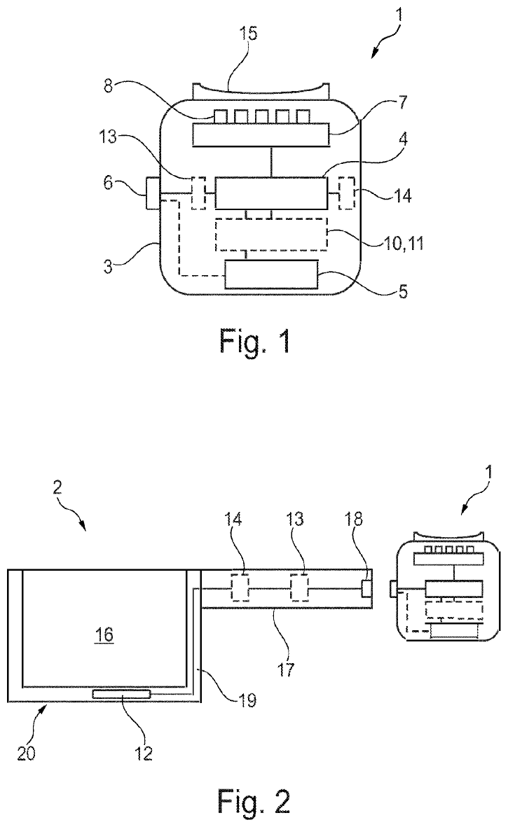

FIG. 1: a sectional view of an electronic module described here,

FIG. 2: a cookware item described herein with a removable electronic module described herein in sectional view,

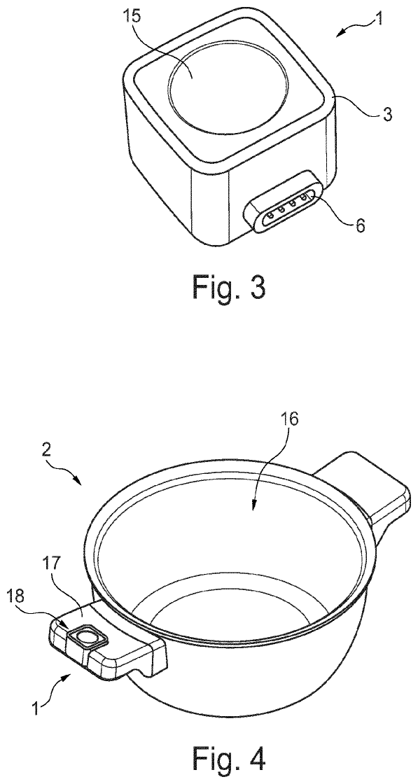

FIG. 3: an embodiment of an electronic module described herein in perspective view,

FIG. 4: an embodiment example of a cookware item described herein with the electronic module from FIG. 3,

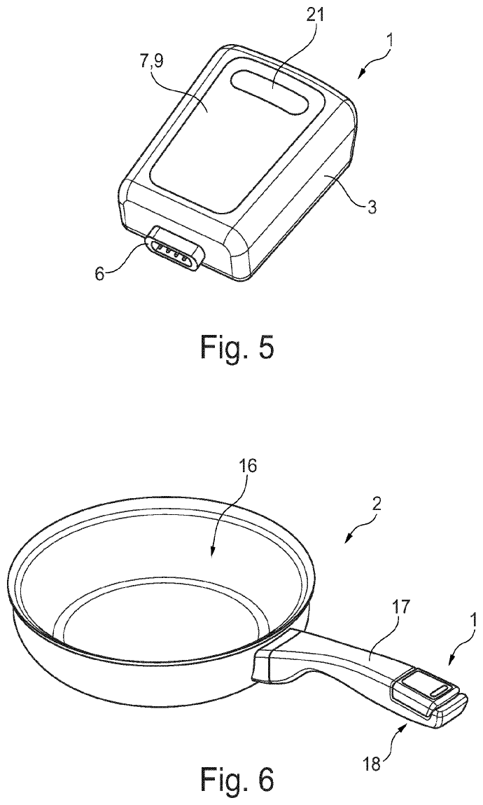

FIG. 5: a further embodiment example of an electronic module described herein in perspective view, and

FIG. 6: an embodiment example of a cookware described herein with the electronic module from FIG. 5.

FIG. 1 shows a schematic example of an electronic module 1 described here in sectional view. The electronic module 1 is suitable for a cookware item 2 (see FIG. 2). In principle, however, the electronic module 1 could also be used for other applications, such as for a grill, oven or the like.

The electronic module 1 comprises a module housing 3. The module housing 3 is here exemplarily formed in the shape of a (comparatively small) cube. Further exemplary the module housing 3 here is formed in way of a capsule. The electronic module 1 also comprises at least one electronic component 4, which is arranged in the module housing 3. The electronic component 4 can, for example, be an electronic evaluation unit, which is, for example in the form of a circuit board.

Furthermore, the electronic module 1 comprises at least one electrical energy storage 5, which is arranged in the module housing 3 and connected to the electronic component 4. The electrical energy storage 5 can, for example, include at least one (replaceable) battery and/or a (rechargeable) accumulator. In addition, the electronic module 1 has at least one electronic connection element 6, which is connected to at least the electronic component 4 or to the electrical energy storage 5, whereby the electronic module 1 is electrically connectable to the cookware item 2 by means of the connection element 6. For this purpose, the connection element 6 can be formed, for example, in the form of a plug with at least one pin. Furthermore, the electronic module 1 can also be connected via the connection element 6 to a docking station for data exchange, a software update and/or energy acquisition.

The electronic module 1 is intended and set up to be placed by magnetic forces relative to the cookware item 2 (see FIG. 2) and to be detachably held at the cookware item 2. Only exemplary for this reason the shown connecting element 6 is formed at least in sections with a magnetic material.

Furthermore, the electronic module 1 comprises an exemplary display device 7. In the embodiment shown in FIG. 1, the display device 7 comprises, for example, a preferably circular arrangement of several LEDs 8. By means of different circuits or controls of the LEDs 8 within the arrangement, the display device 7 can, for example, visualize data or information that has been determined or evaluated by the electronic component 4. In particular during the use of LEDs 8 the electronic module 1 can have a cover element 15 to cover the LEDs 8. The cover element 15 can, for example, be inserted or integrated in the module housing 3 above the display device 7 in a gas-tight and/or liquid-tight manner. The cover element 15 can be formed at least partially or completely transparent. In particular, if the LEDs 8 are arranged in a circular arrangement, the cover element 15 can have a (correspondingly) circular, possibly convex viewing area.

The electronic module 1 also has an exemplary communication device 10, which is set up for wireless communication. By means of the communication device 10, data or information determined by the electronic module 1 can be transmitted (possibly in addition to a visualization via the display device 7) to (external) third-party devices and/or applications. The communication device 10 can, for example, be used for wireless transmission, for example via Bluetooth, WLAN or similar.

Via the communication device 10, the electronic module 1 can, for example, be integrated into a so-called smart cloud which can comprise various devices and/or applications, such as a refrigerator (not shown here) and/or a smartphone with, for example, a cooking application (app). For example, in this context, the refrigerator can inform the smart cloud which food is available. In this context, the app can suggest, for example, which dishes could be prepared with the food available. The electronic module can monitor in this relation, for example, the cooking process, in particular the temperature curve.

The electronic module 1 can optionally also have at least one detection device 11, which is connected to the electronic component 4. The detection device can, for example, comprise a reader or a scanner. The detection device 11 can be used for, in particular, automatic identification, for example of the type of place of use and/or the type of (connected) cookware item 2. Thus the detection device 11 can, for example, comprise an RFID reader that (automatically) reads or recognizes an RFID code of a cookware item 2 in the vicinity of the electronic module 1.

Furthermore, the electronic module 1 can optionally also include an analogue-digital converter 13 for converting a sensor signal and/or a sensor 14 for detecting at least one movement or position of the electronic module 1 or cookware item 2 and/or a control element 21 (see FIG. 5).

FIG. 2 shows exemplary and schematically a diagram of a cookware item 2 described here with a removable electronic module 1 described here in sectional view. The cookware item 2 has, for example, a cooking chamber 16, a handle 17 and a basement 20. The cookware item 2 described here is an example which has a temperature sensor 12 in the basement 20. The temperature sensor 12 is integrated in a channel 19 in the basement 20. In this context, the basement 20 can, for example, be in the form of a sandwich base with an inserted tube. The basement 20 can be formed with an aluminum layer and one or two steel outer skins. For example, a tube with the temperature sensor 12 can be inserted in the aluminum layer.

In this example, on the handle 17 a mounting 18 for the electronic module 1 is arranged. The mounting 18 can be set up accordingly, for example metallically, particularly magnetically, so that the electronic module 1 can be placed relative to the cookware item 2 by means of magnetic force and held detachably to the cookware item 2 at least in sections in the mounting 18. Furthermore, in the area of the mounting 18 or in the mounting 18a, for example, wired electrical connection can lead to the temperature sensor 12. This is also an example of and possibly how a temperature sensor 12 integrated in the cookware item 2 can be connected to the electronic module 1.

Furthermore, the cookware item 2 can optionally include an analogue-digital converter 13 for converting a sensor signal. The analogue-digital converter 13 can, for example, convert a signal from the temperature sensor 12 from analogue to digital. The analogue-digital converter 13 can be integrated in the electronic module 1 (see FIG. 1) or, as shown here as an example in FIG. 2, arranged in the remaining part of the cookware item 2, here for example the handle 17. For example, the analogue-digital converter 13 can be used advantageously in conjunction with a temperature sensor 12, which can advantageously measure accurately at low voltages and/or supplies at advantageously small space a comparatively weak signal. Particularly in the cases mentioned conversion into a digital signal before reaching the electronic module 1 can be particularly advantageous in order to achieve the best possible overall measurement quality. Furthermore, it can be provided that an analogue-digital converter 13 either in the electronic module 1 or the remaining part of the cookware item 2 is arranged. In other words, this means in particular that no two analogue-digital converters 13 need not be present.

Furthermore, the cookware item 2 can optionally include a sensor 14 for detecting at least one movement or position of the cookware item 2. The sensor 14 can be located (either) in the electronic module 1 (see FIG. 1) or, as illustrated here in FIG. 2 arranged in the remaining part of the cookware item 2, here for example the handle 17. The sensor 14 can be a gyro sensor, for example.

FIG. 3 shows exemplary and schematically a design example of an electronic module described here in perspective view. The reference signs are used consistently so that reference can be made to the previous explanations. In the embodiment example according to FIG. 3, the module housing 3 is formed in the shape of a cube. Furthermore, connection element 6 has an elongated basic shape and has several pins. It is also shown by way of example that the cover element 15 has a convex (visible) area.

FIG. 4 shows a schematic example of an embodiment of a cookware item 2 described here with the electronic module 1 of FIG. 3. The reference signs are used uniformly so that reference can be made to the previous explanations. In the design example shown in FIG. 4, the cookware item 2 is an example of a pot.

FIG. 5 shows an exemplary and schematic view of a further embodiment of an electronic module 1 described here in perspective view. The reference signs are used uniformly so that reference can be made to the previous explanations. In FIG. 5 it is illustrated by way of example, that and, if applicable, how the display device 7 can comprise at least one display 9. Furthermore, it is illustrated by way of example that the electronic module 1 can have an input element 21. This can, for example, be a manually operated button. This can be integrated into the display 9 as shown in FIG. 5. Alternatively, or cumulatively, a touch-sensitive display 9 (so-called touch display) could be used. A user can use the input element 21 to control the electronic module 1, for example, to confirm queries and/or elect menu items. Alternatively, or cumulatively to a control element 21 a control or operation via voice control and/or via an external device via the communication device 10 is possible.

FIG. 6 shows a schematic example of an embodiment of a cookware item 2 described here with the electronic module 1 of FIG. 5. The reference signs are used uniformly so that reference can be made to the previous explanations. In the design example shown in FIG. 6, the cookware item 2 is an example of a pan.

Thus, an electronic module 1 and a cooking item 2 are specified, which at least partially solve the problems described with reference to the prior art. In particular, these at least contribute to improving the interaction between a user and the cookware item 2 in question. In particular, the electronic module 1 or the cookware item 2 can help the user in the planning and/or carrying out a cooking process that can be performed using the cookware item 2. Further advantages can be found in the interchangeability of the electronic module 1 and in the simplified cleaning of the cookware item 2 without electronic module 1.

### REFERENCE SIGNS

1 electronic module
2 cookware item
3 module housing
4 electronic component
5 energy storage
6 connection element
7 display device
8 LEDs
9 display
10 communication device
11 detection device
12 temperature sensor
13 analogue-digital converter
14 sensor
15 cover element
16 cooking chamber
17 handle
18 mounting
19 channel
20 basement
21 control element

1. Electronic module for at least one kitchen appliance, the electronic module at least comprising:
one module housing,
at least one electronic component, that is arranged in the module housing,
at least one electrical energy storage, that is arranged in the module housing and connected to the electronic component,
a control element for controlling the electronic module by a user,
wherein the electronic module is configured to detect information from the kitchen appliance,
wherein the electronic module has a sensor to collect at least a movement or a positioning of the electronic module or of the kitchen appliance, which is a gyro sensor and/or an acceleration sensor,
wherein the electronic module is intended and set up for the purpose of being placed with magnetic force in at least one predefined arrangement relative to the kitchen appliance being detachably held at the kitchen appliance.

2. The electronic module according to claim 1, further comprising:
at least one electronic connection element, which is at least connected to the electronic component or the energy storage, wherein the electronic module is electrically connectable with the connecting element to the kitchen appliance.

3. The electronic module according to claim 1 further comprising a display device, wherein the display device comprises at least an arrangement of a number of LEDs or at least a display.

4. (canceled)

5. (canceled)

6. The electronic module according to claim 1, further comprising a communication device for a wireless communication.

7. The electronic module according to claim 1, further comprising a detection device, that is connected to the electronic component.

8. (canceled)

9. (canceled)

10. A cookware item with the electronic module according to claim 1, in which the electronic module is detachable from the cookware item.

11. The cookware item according to claim 10, with a handle, in which the electronic module is integrable.

12. (canceled)

13. The cookware item according to claim 10, with an integrated temperature sensor, that is connectable with the electronic module.

14. (canceled)

15. The cookware item according to claim 10, wherein the electronic module with the sensor is configured to detect a knocking on and/or turning of the cookware item and to undertake an automatic setting.

16. The electronic module according to claim 1, wherein the control element comprises the sensor.

17. A set containing an electronic module as a module and a number of cooking appliances without own electronic control unit and/or a number of cookware items, wherein the electronic module is interchangeably connectable with the kitchen appliances and/or the cookware items.

18. A set according to claim 17, wherein in each case a number of kitchen appliances and/or cookware items of different types are contained.

19. A method for preparing meals with a cookware item according to claim 10, the method comprising at least the following steps:
a) electing a meal to prepare with an application software, which can provide information for the electronic module,
b) connecting the electronic module with the cookware item,
c) performing of a cooking process or a simmering process for preparing the meal in the cookware item, and
d) monitoring the cooking process or the simmering process with the electronic module.

20. A method according to claim 19, at which through knocking on and/or turning of the cookware item an automatic setting of predetermined temperatures and/or predetermined times is being performed.

21. A method according to claim 19, at which the electronic module is set up to analyze a sensor signal of a temperature sensor integrated in the cookware item, wherein the application software and/or the electronic module send a message in the form of an instruction or a warning acoustically and/or visually and/or through a vibration, when during a monitored simmering process a temperature curve and/or at least one temperature limit value is not being complied with.
